(19) United States
(12) Patent Application Publication
(10) Pub. No.: US 2018/0031528 A1
(43) Pub. Date: Feb. 1, 2018

(54) MEANS AND METHODS FOR MINIMIZING SWEPT AND DEAD VOLUMES IN CHROMATOGRAPHIC APPLICATIONS

(71) Applicant: MAX-PLANCK-GESELLSCHAFT ZUR FÖRDERUNG DER WISSENSCHAFTEN E.V., Munich (DE)

(72) Inventors: Nils KULAK, Munich (DE); Matthias MANN, Planegg (DE)

(21) Appl. No.: 15/549,656

(22) PCT Filed: Feb. 5, 2016
(86) PCT No.: PCT/EP2016/052490

§ 371 Date: Aug. 8, 2017

(30) Foreign Application Priority Data
Feb. 9, 2015 (EP) 15154374.1

(51) Int. Cl. G01N 30/60; B01D 15/32; G01N 30/80; B01D 15/24; G01N 30/38; G01N 30/74

(52) U.S. Cl. CPC G01N 30/6004; G01N 30/38; G01N 30/74; G01N 30/80; B01D 15/247; B01D 15/325; G01N 2030/6013; G01N 2030/027

(57) ABSTRACT

The present invention relates to a device for preventing band broadening and remixing of separated fractions, and associated method, comprising a chromatographic column coupled to a flow selector, such as a rotary valve, wherein said flow selector is connected to the distal end of said column such that the sum of post-column swept volume and post-column dead volume is less than 10 μL. Preferably, the column is directly plugged into the inlet port of the rotary valve and the sample is fractionated at the outlet port.

### RELATED APPLICATIONS

This application is the National Phase of International Application No. PCT/EP2016/052490, filed Feb. 5, 2016, which designates the U.S. and that International Application was published under PCT Article 21(2) in English, which claims priority to European Application No. EP15154374.1, filed Feb. 9, 2015, all of which applications are expressly incorporated herein by reference in their entirety.

### BACKGROUND OF THE INVENTION

### 1. Field of the Invention

The present invention relates to a device comprising or consisting of (a) a chromatographic column; and (b) a flow selector, wherein said flow selector is connected to the distal end of said column such that the sum of post-column swept volume and post-column dead volume is less than 10 μL.

In this specification, a number of documents including patent applications and manufacturer's manuals are cited. The disclosure of these documents, while not considered relevant for the patentability of this invention, are herewith incorporated by reference in their entirety. More specifically, all referenced documents are incorporated by reference to the same extent as if each individual document was specifically and individually indicated to be incorporated by reference.

### 2. Description of Related Art

Fractionation technologies are used in many scientific research and production processes such as those found in chemistry or biology. The aim of fractionation is to reduce the complexity of samples of interest or to purify and deplete unspecific compounds. Most fractionation technologies are based on chemical and/or physical properties which distinguish the desired compounds from the other content of the sample. Especially chromatography systems such as liquid chromatography (LC) are used for sample fractionation and sample collection for direct analysis or for further processing. The fractionation efficiency of chromatographic fractionation depends mainly on the chemistry of the chromatography matrix (Meyer, Practical High-Performance Liquid Chromatography (2004)). However, especially post-column swept and dead volumes can contribute to turbulent flow and back-mixing of the separated compounds thereby decreasing fractionation performance.

Particularly high-performance LC systems are applied due to the superior fractionation efficiencies and swept and dead volumes can be detrimental to the application. Typically increased flow-rates, zero dead volume connections, and narrow and short tubing are used to decrease the opportunity and duration of back-mixing. Depending on the application, however, long tubing could sometimes not be avoided and smaller inner diameters can lead to high backpressures. For example, state-of-the-art fraction collector systems used with LC fractionation systems need to have long tubing to reach the vials in which the fractions are collected. These fraction collectors typically consist of an X-/Y-robot arm or collection plate which positions the tubing above or inside the tube where the sample is collected (FIG. 1). The restriction of space and tubing length are an intrinsic problem of conventional fraction collection systems.

A specific field of fractionation is multi-dimensional fractionation to achieve superior fractionation by using a various orthogonal chemistries to fractionate the sample. These methods are especially interesting if very complex samples with highly-similar compounds are to be fractionated. The dimensions are commonly chosen to separate fractions by distinct physio-chemical properties. For example, ion-exchange as first and reversed-phase chromatography as second dimension are subsequently performed to separate the compounds according to their charge first and by their hydrophobicity afterwards. These methods can be entirely automatized and are implemented by many LC manufacturers (see, for example, Dionex Technical Note 85; also available at http://www.dionex.com/en-us/webdocs/77308-TN85-HPLC-ESI-MS-2D-Peptides-14Jul2009-LPN2256-01.pdf). Even though many chromatography phases can be combined the final efficiency is strongly affected by the less efficient fractionation technology. Furthermore no phase can be perfectly orthogonal and therefore the first dimension affects the fractionation efficiency of the second dimension. The development of concatenation schemes to mix multiple fractions of limited orthogonal first dimension to achieve less effect on the second dimension is a relatively novel concept to reduce orthogonality effects (Dwivedi et al., Anal. Chem., 80(18): 7036-42 (2008)). This method is especially useful if similar chromatography phases are used and the properties of the compounds are changed according to their pH or affinity using different chromatography conditions. In the concatenation scheme many fractions are generated in the first dimension. The fractions are then mixed in a defined distance to each other. For example, 60 fractions are mixed so that fractions 1, 11, 21, 31, 41, 51 are pooled, fractions 2, 12, 22, 32, 42, 52 are pooled and so forth to obtain ten fractions finally. This method necessitates only sufficient orthogonality to span fractions 1 to 10 but also require very high fractionation efficiency in the first dimension to avoid back-mixing.

WO 2005/114168 describes a device for sample analysis. Owing to the device being a microfluidic device, no fittings are required after the column comprised in the device. This document is silent about the collection of fractions.

### SUMMARY OF EMBODIMENTS OF THE INVENTION

The technical problem underlying the present invention is the provision of improved means and methods for chromatographic separation of analytes. This problem is solved by the subject-matter of the claims.

The present invention relates to a device for preventing band broadening and remixing of separated fractions, and associated method, comprising a chromatographic column coupled to a flow selector, such as a rotary valve, wherein said flow selector is connected to the distal end of said column such that the sum of post-column swept volume and post-column dead volume is less than 10 μL. Preferably, the column is directly plugged into the inlet port of the rotary valve and the sample is fractionated at the outlet port.

### BRIEF DESCRIPTION OF THE DRAWINGS

FIG. 1: Examples of art-established fraction collection systems.

FIG. 2: Rotor valves for the splitting of flows.

FIG. 3: Preliminary results comparing the selector fractionation system to state-of-the-art fractionation results.

### DETAILED DESCRIPTION OF EXEMPLARY EMBODIMENTS OF THE INVENTION

Accordingly, the present invention relates to a device comprising or consisting of (a) a chromatographic column; and (b) a flow selector, wherein said flow selector is connected to the distal end of said column such that the sum of post-column swept volume and post-column dead volume is less than 10 μL.

The device according to the first aspect comprises or consists of two constituent elements, namely chromatographic column, which may be full or empty, and a flow selector. A flow selector as such is an art-established device which provides for directing an incoming flow of fluid to one out of several possible outlets (also referred to as “channels” herein). Preferred implementations thereof are rotor valves as detailed further below. A fluid in accordance with the invention may be a liquid (preferred) or a gas.

The terms “upper end” and “lower end” refer to columns which are configured such that the direction of the flow within the column coincides with the direction of gravity. More generally speaking, and especially having regard to columns operated under pressure, a column has a proximal and a distal end, wherein the terms “proximal end” and “upper end” as used herein designate the end where the sample is loaded, and the terms “distal end” and “lower end” designate the end where analytes, after having been separated or partially separated from each other, leave the column.

Importantly, the connection between said chromatographic column and said flow selector is essentially direct such that the requirement of the first aspect can be met. Implementations of such substantially direct connection are further detailed below. Provided with the guidance offered in this specification, the skilled person is in a position to meet the requirement of the first aspect without further ado. As a general rule, the shorter the connection between said chromatographic column and said flow selector, the smaller post-column swept volume and post-column dead volume will be. Preferably, any tubing connecting said column and said flow selector is avoided.

It is understood that the flow selector is external to the column.

As will be apparent from the following, a sum of post-column dead and swept volume of less than 10 μL is below of what has been achieved so far. Values below this threshold have been achieved by the present inventors (see below).

The term “post-column swept volume” is here defined as the proportion of liquid within the flow-path from the distal end of the column to the site where fractionation, i.e. the splitting of fractions in said flow selector occurs. The term “post-column dead volume” designates volumes from the distal end of the column to the site where fractionation, i.e. the splitting of fractions in said flow selector occurs which are not swept and are not directly in the flow-path of the fluid. Post-column dead and swept volumes are volumes which can be reached by the analytes after having left the chromatographic column and prior to entering the vessel or the vessels used for collecting said fluid. In case of the dead volume, diffusion is one of the processes which allow analytes to enter. Given that the dead and swept volumes are confined at one end by the distal end of the chromatographic column, they are also referred to as “post-column” dead/swept volume. As is apparent from the above, swept volume and dead volume are independent parameters which can be optimized independently. The present invention aims at minimizing the sum of dead and swept volumes which sum is also referred to as “post-column volume” or “total post-column volume”. The total post-column volume is confined by the distal end of the chromatographic column and the outlet port of the flow selector and otherwise occupies any volume accessible to analytes between said distal end of the chromatographic column and said outlet port of the flow selector.

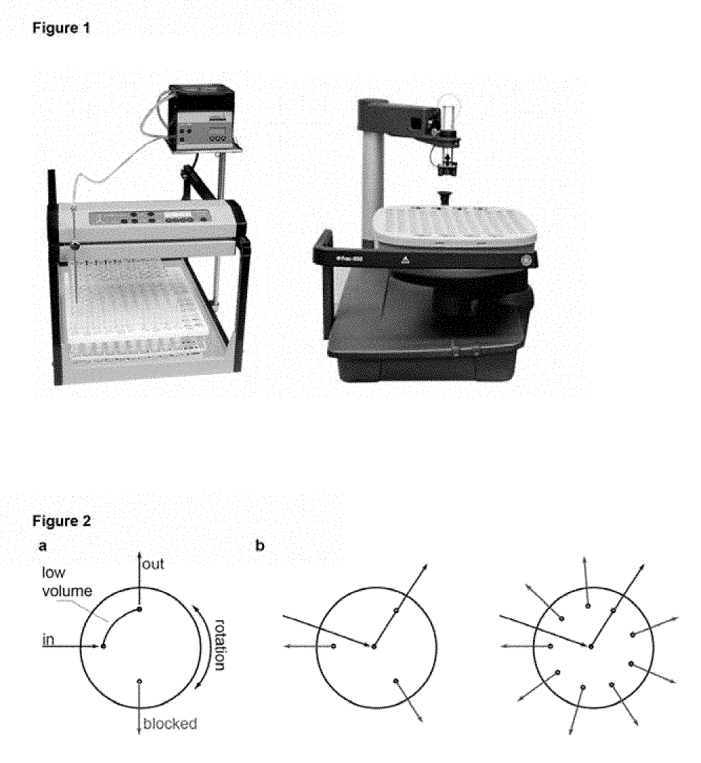

Swept volumes can be either calculated or measured. Calculation can be done on the basis of lengths and dimensions of tubings of a chromatographic system (e.g. those displayed in FIG. 1). Measurements can be done by performing chromatography in a leak-free and preferably also dead volume-free system at a known flow rate and determining the delay of a given expected signal. The term “leak” means that the system is not tight and liquid can leak though a hole in the flow path. This may happen in high-performance chromatography where the high pressure causes leakages. Leaks can be avoided by checking for proper tightness of the entire system. Based column void volume and flow rate, the point in time may be calculated when the first analyte (assuming it would not be retarded on the column) should reach the flow selector. Any deviation therefrom is indicative of and a measure of the post-column swept volume. Dead volumes typically occur within fittings. By appropriately choosing and properly using fittings, dead volumes can be minimized.

The system is highly versatile and improves fractionation of few compounds as well as multiple fractions. The term “fractions” (plural) refers to at least two, at least three, at least four, at least five, at least six, at least seven, at least eight, at least nine or at least ten fractions.

Furthermore the invention is suited for concatenated fractionation as described above. The concept relies on immediate active splitting of the eluting flow in separate channels behind the column and thereby reducing or even removing post-column swept and dead volumes. The flow can be split in two or more channels depending on the application and complexity of the sample to be fractionated. Note that in conventional devices (such as those shown in FIG. 1) the site of fractionation is at the end of the tubing. The art failed to recognize the inherent deficiency of this method of fractionating. According to the invention, though, the site of fractionation is the outlet port of the flow selector.

An exemplary nano-flow fractionation system of the invention has a post-column swept volume of approximately 80 nL only and a post-column dead volume below 10 nL. Classical fraction collection systems have a sum of post-column swept and dead volumes of 10 μL or larger.

Flow rates, i.e. volumes per time unit such as volume per minute are commonly used in the art in order to characterize a chromatographic process. In the course of said process, it can be determined in a straightforward manner.

The invention provides superior performance at very little cost per system. It is a simple method to optimize fractionation conditions for complex samples. It can be used with ultra-high pressure nano-flow pumps for low micro- and nano-flow applications. The invention allows superior fractionation and automation of concatenated fractionation schemes.

In a second aspect, the present invention provides a kit comprising or consisting of (a) a chromatographic column; and (b) a flow selector, wherein said column and said flow selector are configured for a connection of said flow selector to the distal end of said column such that the sum of post-column swept volume and post-column dead volume is less than 10 μL.

The kit according to the second aspect provides the two constituent elements of the device according to the first aspect in separate form. Importantly, the two constituent elements are configured as required by the second aspect, i.e. for an essentially direct connection. Exemplary and preferred implementations of such being configured for an essentially direct connection are further detailed below and include, for example, screw fittings or ferrules.

Consistent therewith, the kit of the invention may further comprise a manual comprising instructions for assembly of the device according to the first aspect.

In a preferred embodiment of both the device in accordance with the first aspect and the kit in accordance with the second aspect of the present invention, said chromatographic column (a) is empty; or (b) is filled with chromatographic material; and/or has an inner diameter of less than 2 mm; preferably of 250 μm or less; or 200 μm or less and/or has a volume of 2 mL or less, 1 mL or less, 500 μL or less, 200 μL or less, preferably 100 μL or less, 50 μL or less, 20 μL or less, or 10 μL or less.

To the extent the column is filled chromatographic material, it is understood that bead-based columns as well as monolithic columns can be used. To the extent beads are used, preference is given to bead sizes below 30 μm, especially between 0.1 and 10 μm, such as 1.0, 1.5, 1.9 or 2.0 μm.

The term “volume” of a column defines the internal volume of the column, i.e., V=□d2L, d being the internal diameter and L the length of a cylindrically shaped column. Accordingly, the term refers to said column being empty, i.e., free of chromatographic material.

To the extent the column is filled with chromatographic material, said chromatographic material is preferably selected from reversed phase, ion exchange, normal phase, mixed phase, hydrophilic interaction, affinity and size exclusion material.

The above preferred embodiment provides for the use of various classes of chromatographic materials. In either class there are numerous art-established products. To name a few examples, reversed phase materials include C18, C8 and phenyl bonded material. Ion exchange materials include SCX, WCX, SAX, and WAX, and normal phase materials include silica. The majority of silica-based materials are only stable under acidic conditions. Preferred mixed phase materials include sulfonated poly-divinyl benzene (DVB) and sulfonated poly-styrene divinyl benzene (SDB). Manufacturers and their commercially available products include Generik BCX of Sepax Technologies (Newark, Del., US) and SDB-RPS of 3M (e.g. 3M Germany, Neuss). A further manufacturer is Dr. Maisch (Germany). Exemplary hydrophilic interaction materials, also known as “forward phase” materials, include HILIC and ERLIC. Affinity materials include immunoaffinity materials, immobilized metal ions (IMAC) and materials based on protein interactions. Size exclusion materials include agarose and dextran.

The invention may be implemented with columns for nano-flow applications or micro-flow applications. Typically, the term “nano-flow” refers to a flow of 1 to 1000 nL/min, and the term “micro-flow” to a flow rate of 1 to 1000 μL/min.

Preferably, said column is for liquid chromatography. Also preferred is that the column consists of or comprises a tube for micro-flow or nano-flow. In other terms, the inner diameter is preferably in a range between 0.05 and 2 mm. Preferred inner diameters are 0.05 mm or less, 0.075 mm or less, 0.1 mm or less, 0.2 mm or less, 0.25 mm or less, 0.5 mm or less, 1.0 mm or less, 1.5 mm or less and 1.6 mm or less.

Preferred column lengths are from 1 cm to 100 cm, particularly preferred from 10 cm to 50 cm.

In preferred embodiments of both the device and the kit of the present invention, said selector is an n-way rotor valve, n preferably being 2, 3, 4, 5, 6, 7, 8, 9, 10, 11, 12, 13, 14, 15, 16, 17, 18, 19, 20, 21, 22, 23 or 24. The more common values of n are 3, 4, 6, 8, 10, 12, 18 and 24. Manufacturers of rotor valves include Vici AG International (Switzerland).

In a further preferred embodiment of both the device and the kit of the invention, the connection between said column and said selector is (a) such that the sum of post-column swept volume and post-column dead volume is less than 1 μL, less than 500 nL, less than 200 nL, less than 100 nL, less than 50 nL, less than 40 nL, less than 30 nL, less than 20 nL or less than 10 nL; and/or (b) implemented by (i) plugging said column directly into the in-port of said selector, preferably with a screw fitting or a ferrule; or (ii) plugging said column directly into a detector such as an UV/vis cell, preferably with a screw fitting or a ferrule; and plugging said detector directly into the in-port of said selector, preferably with a screw fitting or a ferrule.

Items (a) and (b) of this preferred embodiment provide particularly preferred limits of or means for implementing, respectively, the features in accordance with the first and second aspect of the invention.

Items (b)(i) and (b)(ii) provide for preferred implementations which preferred implementations allow for meeting the post-column volume criteria as well as the criteria of item (a) as given above. Item (b)(i) requires a direct connection between the distal end of the column and the in-port of the flow selector. As such, the connection in accordance with item (b)(i) is not only essentially direct, but simply direct. Item (b)(ii) is an implementation of “essentially direct” in that a further device, especially a detector such as an UV/vis cell may be placed between the distal end of the column and the import of the flow selector. If such a device is placed between column and flow selector, it is understood that preferably no extra tubing is used. Instead, for each of the required connections, i.e. the connection between the column and the detector and the connection between the detector and the flow selector means for direct connection are used such as screw fittings.

Standard screw fittings are known in the art and include UNF screw fittings, for example for 1/32″, 1/16″, ⅛″ and the like. Alternatives to screw fittings include ferrules (available, e.g., from Thermo Scientific).

In a further preferred embodiment of the device and the kit of the invention, one, more or all outlets of said flow selector are connected to a vessel. The vessel(s) serve for collecting fraction(s).

In a third aspect, the present invention provides the use of the device according to the first aspect or the kit according to the second aspect for the separation of one or more analytes.

Related thereto, the present invention provides in a fourth aspect a method of analysing a sample, said method comprising (a) performing a first chromatography step of said sample using a device according to the first aspect of the invention, wherein fractions are collected.

The term “analyzing” has its art-established meaning and includes separating, at least partially separating, the constituents of a sample and/or determining their identity. A sample can be any sample, provided that said sample, either in raw or processed form, is a fluid which can be loaded onto the proximal end of the chromatographic column. Preferred samples are samples of biological origin and/or environmental samples. Samples of biological origin include bodily fluids such as bodily fluids originating from a mammal or a human. Examples of bodily fluids include plasma, serum, blood and sputum.

The phrase “performing a first chromatography step” embraces the art-established measures for performing a chromatographic separation of a sample using a chromatographic column (it is understood that said measures are not art-established with regard to post-column swept and dead volumes). To the extent liquid chromatography is to be used, one or more buffers may be used. In certain instances, gradients may be useful. Especially in the latter case, the means and methods disclosed in EP 2944955 may be used. For the sake of completeness, we refer to Meyer, loc.cit. The term “first step” is merely used to distinguish from optional further chromatography steps.

In a preferred embodiment, said fractions are concatenated to collect concatenated fractions. Concatenation of fractions as such is an art-established procedure which is discussed in the background section herein above.

In a further preferred embodiment of the methods in accordance with the fourth aspect, said method furthermore comprises (b) performing a second chromatography step using a device according to the first aspect of the invention with the fractions obtained from said first chromatography step or with the concatenated fractions obtained from said first chromatography step, wherein fractions are collected; and optionally (c) performing one or more further chromatographic step(s) using a device according to the first aspect of the invention with fractions obtained from the respective preceding chromatography step or with concatenated fractions obtained from the respective preceding chromatography step, wherein fractions are collected in said one or more further chromatographic step(s).

This preferred embodiment provides for a second chromatography step and for one or more optional further chromatography steps. Preferably, conditions (such as pH value) and/or chromatographic materials used in the various chromatography steps are different. Ideally, orthogonal separation conditions should be used. The term “orthogonal” refers to a situation where the physiochemical separation conditions and/or selectivity in two distinct chromatography steps are so distinct that the way how analytes are separated is fundamentally different and/or eluents are not eluted in the same order. In practice, this is not always possible to achieve. Preferred implementations of a method using two distinct chromatography steps are described below.

In a preferred embodiment, the chromatographic material used for said first chromatography step and/or for said second chromatography step is reversed phase material.

In a particularly preferred embodiment, the chromatographic material used for said first chromatography step and for said second chromatography step is reversed phase material, and one of first and second chromatography steps is effected under neutral or alkaline conditions, preferably at a pH between 7 and 10, and the other under acidic conditions, preferably at a pH between 1 and 4.

Further preferred alkaline conditions include pH values of 8 and 9. Further preferred acid conditions include pH values of 2 and 3. For practical purposes, we note that acidic conditions are not always characterized in terms of their respective pH value, but instead in terms of the concentration of the acid being present, for example 0.01 to 1%, preferably 0.1% formic acid; 0.01 to 1%, preferably 0.1% trifluoroacetic acid; or 0.01 to 1%, preferably 0.1% acetic acid.

Table 1 below shows preferred pH-modifying agents in accordance with the present invention.

TABLE 1
Preferred pH-modifying agents. The relevant pKₐ values are
indicated in brackets.

| pKₐ (25° C.) | compound |
|---|---|
| 0.3 | trifluoroacetic acid |
| 2.15 | phosphoric acid (pK₁) |
| 3.13 | citric acid (pK₁) |
| 3.75 | formic acid |
| 4.76 | acetic acid |
| 4.76 | citric acid (pK₂) |
| 4.86 | propionic acid |
| 6.35 | carbonic acid (pK₁) |
| 6.40 | citric acid (pK₃) |
| 7.20 | phosphoric acid (pK₂) |
| 8.06 | tris |
| 9.23 | boric acid |
| 9.25 | ammonia |
| 9.78 | glycine (pK₂) |
| 10.33 | carbonic acid (pK₂) |
| 10.72 | triethylamine |
| 11.27 | pyrrolidine |
| 12.33 | phosphoric acid (pK₃) |

In a further preferred embodiment, said first chromatography step is performed in the presence of a mobile phase modifier, said mobile phase modifier preferably being trifluoroacetic acid (TFA) or triethylamine (TEA).

The term “mobile phase modifier” in accordance with the present invention is a functional characterization of compounds which help to improve chromatographic performance (such as peak separation and peak shape). Mobile phase modifiers may act as ion paring reagent for the analytes. To the extent TFA or TEA are used as a mobile phase modifier, it is preferred to use it for the first chromatography step.

In a further preferred embodiment of the method of the invention, said method furthermore comprises (d) mass spectrometry of one or more fractions, said fractions being obtained from said first chromatography step, and/or, to the extent present, said second and/or said further chromatographic step(s).

In a further preferred embodiment of the method of the invention, the flow selector comprised in said device is controlled by a detector, said detector preferably being a UV/vis cell or a mass spectrometer.

The latter preferred embodiment provides for signal dependent fractionation. To explain further, a detector, for example a detector placed between the distal end of the column and the flow selector, or in the alternative a downstream detector such as a mass spectrometer may be used to determine location and properties of a peak, said peak corresponding to an analyte of interest. Depending on the properties of the signal detected by a detector, the flow selector may operate in such a manner that separation and/or collecting a certain analyte is optimal.

In a further preferred embodiment of the method of the invention, chromatography is liquid chromatography (LC).

In a further preferred embodiment of the method of the invention, said sample comprises or consists of peptides, polypeptides, lipids and/or saccharides, wherein said peptides preferably are the result of a proteolytic, preferably tryptic digestion.

As is known in the art, samples comprising peptides, polypeptides and/or proteins, such samples including entire proteomes, are preferably proteolytically digested for the purpose of subsequent mass-spectrometric analysis. Preferred proteolytic enzymes include trypsin. In these embodiments, the sample which is loaded onto the chromatographic column differs from the primary sample drawn from a biological system in that it has undergone pre-processing, said pre-processing comprising or consisting of the mentioned proteolytic digestion.

Generally speaking, and if not expressly indicated to the contrary, preferred embodiments may work in conjunction. To the extent this applies to the latter two embodiments, online LC-MS is a particularly preferred implementation.

As regards the embodiments characterized in this specification, in particular in the claims, it is intended that each embodiment mentioned in a dependent claim is combined with each embodiment of each claim (independent or dependent) said dependent claim depends from. For example, in case of an independent claim 1 reciting 3 alternatives A, B and C, a dependent claim 2 reciting 3 alternatives D, E and F and a claim 3 depending from claims 1 and 2 and reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Similarly, and also in those cases where independent and/or dependent claims do not recite alternatives, it is understood that if dependent claims refer back to a plurality of preceding claims, any combination of subject-matter covered thereby is considered to be explicitly disclosed. For example, in case of an independent claim 1, a dependent claim 2 referring back to claim 1, and a dependent claim 3 referring back to both claims 2 and 1, it follows that the combination of the subject-matter of claims 3 and 1 is clearly and unambiguously disclosed as is the combination of the subject-matter of claims 3, 2 and 1. In case a further dependent claim 4 is present which refers to any one of claims 1 to 3, it follows that the combination of the subject-matter of claims 4 and 1, of claims 4, 2 and 1, of claims 4, 3 and 1, as well as of claims 4, 3, 2 and 1 is clearly and unambiguously disclosed.

The above considerations apply mutatis mutandis to all attached claims.

The figures show:

FIG. 1: Examples of art-established fraction collection systems.

FIG. 2: Rotor valves for the splitting of flows. A) Example of a schematic 2-channel rotor valve. When the position is rotated by 90° the in-line and currently blocked line are connected. B) Two examples of multichannel rotor valves. Here the in-line is connected to a center port and a low volume channel is connected to the radial ports of out-channels (left: example of 3-channel valve, right: example of 9-channel valve).

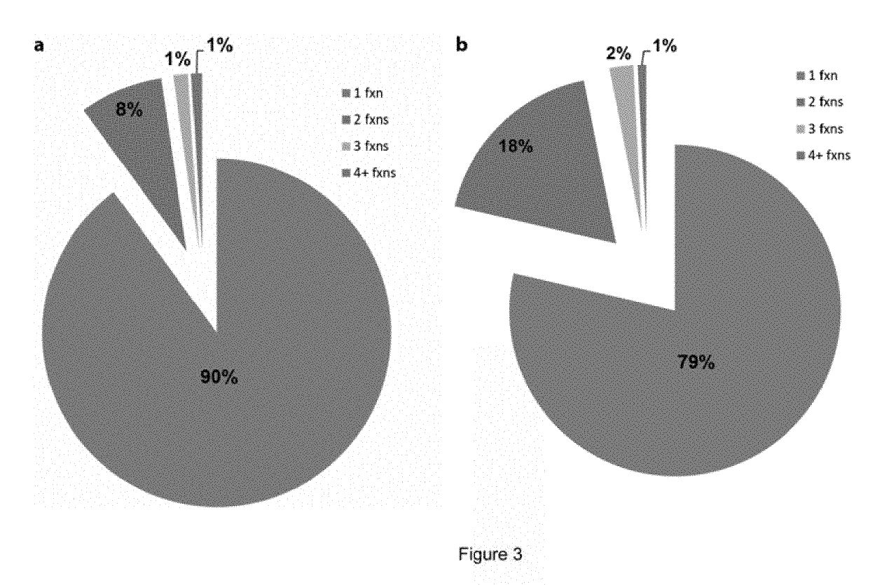

FIG. 3: Preliminary results comparing the selector fractionation system to state-of-the-art fractionation results. A) Fractionation efficiency of the system described herein using 15 μg starting material fractionated with nano-flow. Initial results demonstrate a proteomic depth of 7,793 protein identifications in less than 17 h measuring time. B) Fractionation efficiency achieved in a recently published methodology paper with a regular autosampler and milliliter-flow. In this approach more than 2.5 mg peptides were fractionated. The paper reports a proteomic depth of 7,897 protein identifications analyzed in 60 h total measurement time (Mertins et al., Nat Methods, 10(7): 634-7 (2013)).

The Examples illustrate the invention.

### Example 1

A single or single compounds are to be purified with little quantitative losses and with high purity. In this instance the system can be performed with two or more channels (FIGS. 2a, b) where the eluting peak is directly redirected into a separate channel resulting in perfectly clean separation without detrimental back-mixing effects. Thereby a single compound can be separated from the bulk flow or multiple compounds can be split off into one or multiple separate channels.

### Example 2

A complex sample has to be fractionated into few fractions with little overlap of the fractions content to reduce the complexity of the sample but retain the quantitative differences of the compounds. In this example a rotor valve with multiple out-lines can be used (FIG. 2b). Fraction one is collected, the rotor switches to the next channel and the next fraction is collected and so forth. In this automated fashion few fractions can be separated with very clean separation and little overlap.

### Example 3

A highly complex sample is to be fractionated by a 2D scheme with fractionation concatenation. Here a rotary valve with multiple outputs can be used to fractionate into many sub-fractions which are concatenated into many channels. For instance if a 10-port valve is used the rotor valve switches in a continuous fashion in a circular way. Thereby a concatenation is automatically performed as fraction 1 enters channel 1, channel 2 enters channel 2 and so forth continuing so that fraction 11, 21, 31, 41 etc. also enter channel 1 and fractions 12, 22, 32, 42 etc. enter channel 2. The results demonstrate comparable proteomic coverage with much better efficiency than classical approaches (FIG. 3).

1. A device comprising or consisting of
(a) a chromatographic column; and
(b) a flow selector,
wherein said flow selector is connected to the distal end of said column such that the sum of post-column swept volume and post-column dead volume is less than 10 μL.

2. A kit comprising or consisting of
(a) a chromatographic column; and
(b) a flow selector,
wherein said column and said flow selector are configured for a connection of said flow selector to the distal end of said column such that the sum of post-column swept volume and post-column dead volume is less than 10 μL.

3. The kit of claim 2, furthermore comprising a manual comprising instructions for assembly of a device according to claim 1.

4. The device of claim 1 of the kit of claim 2 or 3, wherein said chromatographic column
(a) is empty; or
(b) is filled with chromatographic material;
and/or
has an inner diameter of less than 2 mm; preferably of 250 μm or less; or 200 μm or less
and/or
has a volume of 2 mL or less, preferably 100 μL or less.

5. The device or kit of claim 4(b), wherein said chromatographic material is selected from reversed phase, ion exchange, normal phase, hydrophilic interaction, affinity and size exclusion material.

6. The device of any one of claim 1, 4 or 5, or the kit of any one of claims 2 to 5, wherein said selector is an n-way rotor valve, n preferably being 2, 3, 4, 5, 6, 7, 8, 9, 10, 11, 12, 13, 14, 15, 16, 17, 18, 19, 20, 21, 22, 23 or 24.

7. The device of any one of claims 1 or 4 to 6, or the kit of any one of claims 2 to 6, wherein the connection between said column and said selector is
(a) such that the sum of post-column swept volume and post-column dead volume is less than 1 μL, less than 500 nL, less than 200 nL, less than 100 nL, less than 50 nL, less than 40 nL, less than 30 nL, less than 20 nL, or less than 10 nL; and/or
(b) implemented by
(i) plugging said column directly into the in-port of said selector, preferably with a screw fitting or a ferrule; or
(ii) plugging said column directly into a detector such as an UV/vis cell, preferably with a screw fitting or a ferrule; and plugging said detector directly into the in-port of said selector, preferably with a screw fitting or a ferrule.

8. Use of the device or the kit according to any one of claims 4(b) or 5 to 7 for the separation of one or more analytes.

9. A method of analysing a sample, said method comprising
(a) performing a first chromatography step of said sample using a device according to claim 4(b) or 5 to 7, wherein fractions are collected.

10. The method of claim 9, wherein said fractions are concatenated to collect concatenated fractions.

11. The method of claim 9 or 10, furthermore comprising
(b) performing a second chromatography step using a device according to claim 4(b) or 5 to 7 with the fractions obtained from said first chromatography step or with the concatenated fractions obtained from said first chromatography step, wherein fractions are collected; and optionally
(c) performing one or more further chromatographic step(s) using a device according to claim 4(b) or 5 to 7 with fractions obtained from the respective preceding chromatography step or with concatenated fractions obtained from the respective preceding chromatography step, wherein fractions are collected in said one or more further chromatographic step(s).

12. The method of any one of claims 9 to 11, wherein the chromatographic material used for said first chromatography step and/or for said second chromatography step is reversed phase material.

13. The method of claim 12, wherein the chromatographic material used for said first chromatography step and for said second chromatography step is reversed phase material, and one of first and second chromatography steps is effected under neutral or alkaline conditions, preferably at a pH between 7 and 10, and the other under acidic conditions, preferably at a pH between 1 and 4.

14. The method of any one of claims 11 to 13, wherein said first chromatography step is effected in the presence of a mobile phase modifier, said mobile phase modifier preferably being trifluoro acetic acid or triethylamine.

15. The method of any one of claims 9 to 14, furthermore comprising
(d) mass spectrometry of one or more fractions, said fractions being obtained from said first chromatography step, and/or, to the extent present, said second and/or said further chromatographic step(s).

16. The method of any one of claims 9 to 15, wherein the flow selector comprised in said device is controlled by a detector, said detector preferably being a UV/vis cell or a mass spectrometer.

17. The method of any one of claims 9 to 16, wherein said sample comprises or consists of peptides, polypeptides, lipids and/or saccharides, wherein said peptides preferably are the result of a proteolytic, preferably tryptic digestion.
